(19) United States
(12) Patent Application Publication
(10) Pub. No.: US 2012/0268539 A1
(43) Pub. Date: Oct. 25, 2012

(54) PRINTING APPARATUS, PRINTING METHOD, AND PROGRAM THEREFOR

(75) Inventors: Takamitsu KONDO, Shiojiri-shi (JP); Toru TAKAHASHI, Azumino-shi (JP); Kazuyoshi TANASE, Matsumoto-shi (JP); Hiroshi WADA, Azumino-shi (JP)

(73) Assignee: SEIKO EPSON CORPORATION, Tokyo (JP)

(21) Appl. No.: 13/452,615

(22) Filed: Apr. 20, 2012

(30) Foreign Application Priority Data
Apr. 25, 2011 (JP) 2011-097394

(51) Int. Cl. B41J 2/01

(52) U.S. Cl. 347/102

(57) ABSTRACT

A printing apparatus includes an ink ejection nozzle configured to eject therethrough a photo-curable ink, onto a medium; and an irradiation portion configured to irradiate the photo-curable ink having been applied to the medium with the light. Further, when printing of an image is performed onto the medium by applying the photo-curable ink, the printing apparatus ejects the photo-curable ink onto the medium such that the photo-curable ink is applied onto an increased portion of an area resulting from expansion of at least one original area, in an outward direction of the at least one original area from an entire edge thereof; the printing apparatus cures the photo-curable ink having been applied onto the medium by irradiating the photo-curable ink with the light from the light irradiation portion; and the printing apparatus removes the photo-curable ink having been applied onto the increased portion from the medium.

### BACKGROUND

1. Technical Field

The present invention relates to a printing apparatus, a printing method and a program therefor.

2. Related Art

There have been well-known printing apparatuses which eject a photo-curable ink (for example, a UV ink) which is cured by irradiation of light (for example, ultraviolet light (UV), visible light or the like). Such a printing apparatus ejects the UV ink onto a medium through nozzles thereof, and subsequently irradiates dots having been formed on the medium with the light; whereby the dots are cured, and finally become fixed to the medium (for example, refer to JP-A-2000-158793).

Meanwhile, the photo-curable ink is unlikely to penetrate into a medium. Therefore, in the case where printing of images is performed by using the photo-curable ink, dots composing print images are formed in a protuberant condition to a great degree, as compared with a case where printing of the images is performed by using a penetrative ink (for example, an aqueous ink).

Further, the inventors of the invention have discovered a phenomenon (a thick-protuberance phenomenon), in which, when printing of images is performed under the condition where the ink jet method is employed and the photo-curable ink is used, portions nearby edges of print images protuberate to a greater degree than other portions. Moreover, the inventors of the invention have discovered that, because of the thick-protuberance phenomenon, there occurs a phenomenon in which, when the print images are viewed under the state where light rays are mirror-reflected at only parts of the print images, the thicknesses of the print images are perceived as larger ones than actual ones, and thus, the print images look like three-dimensional objects, so that this phenomenon leads to a cause of deterioration of quality of print images.

### SUMMARY

An advantage of some aspects of the invention is to provide a technology which makes it possible to improve quality of print images resulting from printing employing the ink jet method and using a photo-curable ink.

According to a main aspect of the invention, a printing apparatus includes an ink ejection nozzle configured to eject a photo-curable ink, which is cured upon receipt of irradiation of light, onto a medium; and an irradiation portion configured to irradiate the photo-curable ink having been applied to the medium with the light. Further, when printing of an image is performed onto the medium by applying the photo-curable ink, the printing apparatus ejects the photo-curable ink onto the medium through the ink ejection nozzle such that the photo-curable ink is applied onto an increased portion of an area resulting from expansion of at least one original area, onto which the photo-curable ink is originally to be applied in order to achieve printing of the image, in an outward direction of the at least one original area from an entire edge of the at least one original area, in addition to the at least one original area; the printing apparatus cures the photo-curable ink having been applied onto the medium by irradiating the photo-curable ink with the light from the light irradiation portion; and the printing apparatus removes the photo-curable ink having been applied onto the increased portion from the medium.

Other aspects of the invention will be apparent from this patent specification and the accompanying drawings.

### BRIEF DESCRIPTION OF THE DRAWINGS

The invention will be described with reference to the accompanying drawings, wherein like numbers reference like elements.

FIG. 1A is a diagram illustrating a print image which is obtained by printing an image on a medium by using a UV ink; and FIG. 1B is a diagram illustrating a graph which indicates measurement values of thicknesses within an area (nearby an edge) enclosed by the dotted line of FIG. 1A.

FIG. 2A is a diagram illustrating an upper direction view of the print image shown in FIG. 1A; and FIG. 2B is a diagram illustrating a state where light rays are mirror-reflected at part of the print image shown in FIG. 2A.

FIGS. 3A and 3B are diagrams illustrating an outline of embodiments of the invention; FIG. 3A is a diagram illustrating an application area of a color ink, according to embodiments of the invention, and FIG. 3B is a diagram illustrating a removal process according to embodiments of the invention.

FIG. 4 is a block diagram illustrating an entire configuration of a printer according to a first embodiment of the invention.

FIG. 5 is a diagram illustrating an entire configuration of a printer according to a first embodiment of the invention.

FIG. 6 is a diagram illustrating functions of a printer driver of a computer, according to a first embodiment of the invention.

FIG. 7 is a flowchart illustrating a to-be-removed image generation process according to a first embodiment of the invention.

FIGS. 8A to 8D are diagrams illustrating image data according to a first embodiment of the invention; FIG. 8A is a diagram illustrating image data (an original image) having been subjected to a halftone process, according to a first embodiment of the invention; FIG. 8B is a diagram illustrating edge pixels according to a first embodiment of the invention; FIG. 8C is a diagram illustrating image data for ejection of a UV ink, according to a first embodiment of the invention; and FIG. 8D is a diagram illustrating image data for ejection of a processing solvent, according to a first embodiment of the invention.

FIGS. 9A to 9C are diagrams illustrating states of a print surface of a medium when printing processing is performed, according to a first embodiment of the invention; FIG. 9A is a diagram illustrating a state of a print surface of a medium having been subjected to a preliminary process, according to a first embodiment of the invention; FIG. 9B is a diagram illustrating a state of a print surface of a medium having been subjected to an application of a UV ink, according to a first embodiment of the invention; and FIG. 9C is a diagram illustrating a state of a print surface of a medium when a removal process is performed, according to a first embodiment of the invention.

FIG. 10 is a diagram illustrating a state of a print surface of a medium having been subjected to a preliminary process, according to an improved example of a first embodiment of the invention.

FIG. 11 is a diagram illustrating a printing apparatus according to a second embodiment of the invention.

### DESCRIPTION OF EXEMPLARY EMBODIMENTS

According to this patent specification and the accompanying drawings, at least the following items will be apparent.

It will be apparent that a printing apparatus according to embodiments of the invention includes an ink ejection nozzle configured to eject a photo-curable ink, which is cured upon receipt of irradiation of light, onto a medium; and an irradiation portion configured to irradiate the photo-curable ink having been applied to the medium with the light. Further, when printing of an image is performed onto the medium by applying the photo-curable ink, the printing apparatus ejects the photo-curable ink onto the medium through the ink ejection nozzle such that the photo-curable ink is applied onto an increased portion of an area resulting from expansion of at least one original area, onto which the photo-curable ink is originally to be applied in order to achieve printing of the image, in an outward direction of the at least one original area from an entire edge of the at least one original area, in addition to the at least one original area; the printing apparatus cures the photo-curable ink having been applied onto the medium by irradiating the photo-curable ink with the light from the light irradiation portion; and the printing apparatus removes the photo-curable ink having been applied onto the increased portion from the medium.

According to such a printing apparatus, the feeling of a thick protuberance can be suppressed, and thus, it is possible to improve quality of print images.

Further, preferably, before applying the photo-curable ink, a processing solvent which has a property of repelling the photo-curable ink is applied onto the increased portion. In this way, it is possible to facilitate a removal process.

Alternatively, the processing solvent is applied onto an area resulting from expansion of the increased portion in an outward direction of the increased portion from an entire edge of the increased portion, excluding an edge contacted with the at least one original area. In this way, it is possible to suppress the photo-curable ink to be removed from remaining on the medium.

Preferably, before applying the photo-curable ink, a fixing agent for fixing the photo-curable ink to the medium is applied onto the at least one original area. In this way, it is possible to prevent the print image to be remaining on the medium from being removed from the medium.

Preferably, the printing apparatus further includes a first member and a second member configured to chip off the photo-curable ink from the medium, and a direction in which the first member chips off the photo-curable ink and a direction in which the second member chips off the photo-curable ink are different from each other. In this way, it is possible to suppress the photo-curable ink to be removed from remaining on the medium.

Preferably, the printing apparatus further includes an air blower configured to blow away chips of the photo-curable ink having been chipped off from the medium. In this way, it is possible to suppress re-adherence of the chipped-off photo-curable ink to the medium.

It will be apparent that, according to embodiments of the invention, a printing method for performing printing of an image onto a medium by using a photo-curable ink which is cured upon receipt of irradiation of light includes ejecting the photo-curable ink onto the medium through an ink ejection nozzle such that the photo-curable ink is applied onto an increased portion of an area resulting from expansion of at least one original area, onto which the photo-curable ink is originally to be applied in order to achieve printing of the image, in an outward direction of the at least one original area from an entire edge of the at least one original area, in addition to the at least one original area; curing the photo-curable ink having been applied to the medium by irradiating the photo-curable ink with the light; and removing the photo-curable ink having been applied onto the increased portion from the medium.

According to such a printing method, the feeling of a thick protuberance can be suppressed, and thus, it is possible to improve quality of print images.

### General Description

### Regarding Thick-Protuberance Phenomenon and Feeling of Thick Protuberance

Since a medium, such as a plastic film, has the property of being unlikely to absorb ink. Therefore, when printing employing the ink jet method is performed onto such a medium, sometimes, UV inks are used as photo-curable inks. Such a UV ink is an ink having the property of becoming cured upon receipt of irradiation of ultraviolet light rays. A method of forming dots by curing the UV ink enables execution of printing onto even ink-non-absorbent media each not having any ink-receptive layers.

But, the dots having been formed by curing the UV ink are likely to protuberate on the surface of the medium, and thus, print images, which have been formed on the medium by using the UV ink, have concavo-convex portions on the surface of the medium. Further, if the print image is such an image that is filled with ink, the print image results in having a thickness.

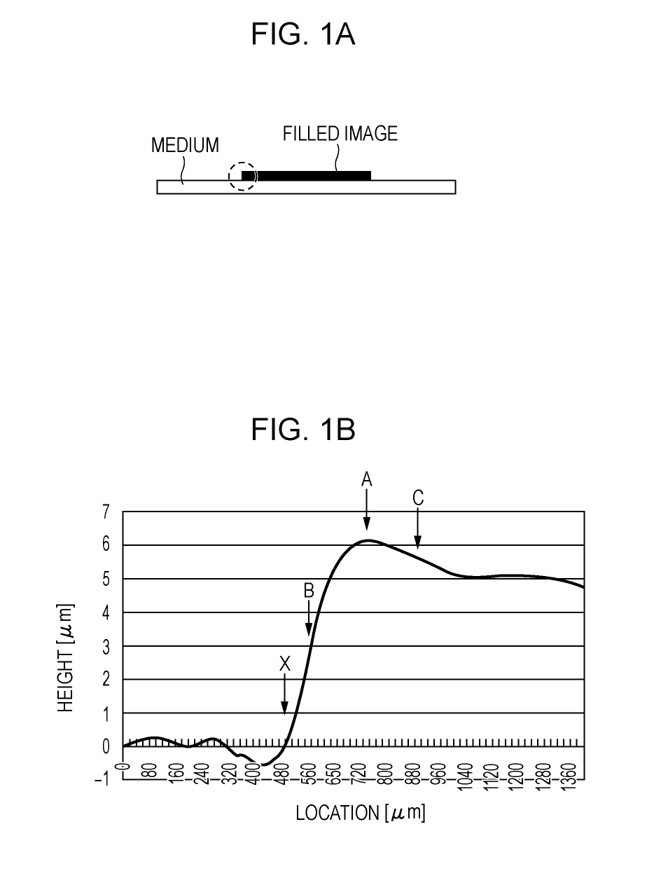

FIG. 1A is a diagram illustrating a print image which is obtained by printing an image on a medium by using a UV ink.

The UV ink is unlikely to penetrate into the medium, and thus, in the case where printing of an image is performed by using the UV ink, dots are formed in a protuberant condition. Further, in the case where printing such an image that is filled with ink (a filled image) is performed, dots having been formed by using the UV ink completely cover a predetermined area, so that a print image having a certain thickness is formed on the medium. For example, in the case where printing of a certain character is performed on a medium, as a result, a character image (an example of the filled image) is formed on the medium. The thickness of the print image resulting from printing using the UV ink is approximately several micrometers.

FIG. 1B is a diagram illustrating a graph which indicates measurement values of thicknesses within an area (nearby an edge) enclosed by the dotted line of FIG. 1A. The horizontal axis of the graph indicates the locations relative to the medium, and the vertical axis of the graph indicates the heights of the dots (i.e., the thicknesses of the print image). In addition, this print image is a print image obtained by forming dots whose ink weight is set to 10 mg, and filling an area corresponding to the print image at a print resolution of 720×720 dpi. The thicknesses of this print image were measured by using a non-stop CNC image measurement instrument, Quick Vision Stream Plus, which is a product of Mitsutoyo Cooperation. As shown in FIG. 1B, the thickness of this print image is around 5 μm.

A location “X” shown in FIG. 1B indicates the location of the most outside of the print image. In other words, the location “X” indicates the location of an edge (a contour) of the print image. A location “A” shown in FIG. 1B indicates the location of the thickest portion (the highest portion) in an area nearby the edge of the print image. In other words, the location “A” indicates the location of a protuberant portion in an area nearby the edge of the print image.

The location “A” is located at the position which exists at an inner side from the location “X”, and which is distanced from the location “X” by approximately 200 p.m. Within an area between the location “X” and the location “A” (i.e., within an area “B” of a curved line shown in the graph), the curved line is inclined with a state in which the more inner position of the print image a measurement point is located at, the larger the thickness of the print image at the measurement point becomes. Although the scales of the vertical axis and horizontal axis do not correspond to each other, actually, the curved line within the area “B” is inclined with an angle less than 3 degrees. Further, within an area at the more inner side than the location “A” (i.e., within an area “C” of the curved line shown in the graph), the more inner position of the print image a measurement position is located at, the smaller the thickness of the print image at the measurement position becomes. Further, after the width of the print image has reached a value of around 5 μm, it becomes an approximately uniform width.

In this patent specification, a phenomenon, in which a portion nearby the edge of the print image protuberates to a greater degree than other portions just like the portion indicated by the location “A” of the graph, is referred to as “a thick-protuberance phenomenon”. This thick-protuberance phenomenon is a specific phenomenon which occurs when printing of images is performed under the condition where the ink jet method is employed and the UV ink is used.

A mechanism of occurrence of the thick-protuberance phenomenon is not clear, but, according to a speculation, the mechanism thereof is considered as follows. The UV ink has a higher degree of viscosity than penetrative inks, but, has a certain degree of fluidity enough to make it possible to be ejected through nozzles under the condition where the ink jet method is employed (such a property required in the ink jet method, that is, a certain degree of fluidity enough to make it possible to be ejected through nozzles, is a specific property different from those of inks used in plate-making printings). After having been applied to the medium, the UV ink still maintains the fluidity during a period until the UV ink is completely cured by irradiation of ultraviolet light rays. It has been considered that, because of the influence of this fluidity of the UV ink having been applied to the medium, the thick-protuberance phenomenon occurs in an area nearby the edge of the print image.

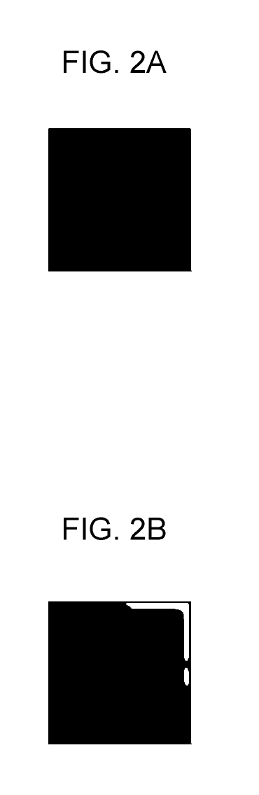

FIG. 2A is a diagram illustrating an upper direction view of the print image of FIG. 1A. FIG. 2B is a diagram illustrating a state where light rays are mirror-reflected at part of the print image shown in FIG. 2A. In FIG. 2B, a gleaming portion which is viewed inside the print image is drawn in white color.

In the central portion of the print image, the thickness thereof is substantially uniform, and thus, it is possible to obtain a uniform degree of brilliance. But, in the portion nearby the edge of the print image, the thickness thereof is not uniform, and thus, it is difficult to obtain the uniform degree of brilliance.

In the portion nearby the edge of the print image, the thickness thereof is not uniform because of occurrence of the thick-protuberance phenomenon, and at the more inner side than the edge (contour) of the print image, protuberant portions along the edge thereof are formed. As a result of this phenomenon, depending on a reflection angle of light rays, sometimes, as shown in FIG. 2B, a scene, in which part of the print image is gleaming along the edge thereof, is viewed. This is because, depending on a location relation and an angle relation with respect to a viewer's eyes, a light source and the print image, light rays, which have been mirror-reflected at the inclined area shown in FIG. 1B, enter the viewer's eyes, so that the print image is viewed, such as shown in FIG. 2B.

Under the condition where a scene, in which part of the print image is gleaming along the edge thereof, is viewed, such as shown in FIG. 2B, as a result, the entire print image is perceived as a three-dimensional object. Figuratively, just like a case where, in a computer graphics, when a three-dimensional object is displayed on a display as a two-dimensional image, part of the object is displayed with a high luminance (for example, just like a case where a three-dimensional object is displayed as a two-dimensional image by means of a ray tracing method), the print image is perceived as a three-dimensional object. Consequently, although, actually, the thickness of the print image is around 5 μm, upon view of the print image, the viewer perceives the thickness thereof as a larger one.

In this patent specification, the phenomenon, in which the thickness of a print image is perceived as a larger one than the actual one because of the thick-protuberance phenomenon, is referred to as “the feeling of a thick protuberance”. The problem of “the feeling of a thick protuberance” is a specific problem which occurs when printing of images is performed under the condition where the ink jet method is employed and the UV ink is used.

In addition, print images generated by general plate-making printing processes (a flexographic printing process, an offset printing process and the like) have significantly small thicknesses, as compared with those generated by printing processes using the UV ink. Therefore, for the print images generated by the general plate-making printing processes, “the thick-protuberance phenomenon” does not occur, and the problem of “the feeling of a thick protuberance” does not occur, either. Furthermore, print images generated by a printing process employing a method of causing an ink to be penetrated into a medium also have significant small thicknesses. Therefore, for the print images generated by the printing process employing a method of causing an ink to be penetrated into a medium, similarly, “the thick-protuberance phenomenon” does not occur, and the problem of “the feeling of a thick protuberance” does not occur, either. As described above, the thick-protuberance phenomenon and the feeling of a thick protuberance are a specific phenomenon and a specific problem, respectively, which occur when printing of images is performed under the condition where the ink jet method is employed and the UV ink is used.

### Outline of Embodiments According to the Invention

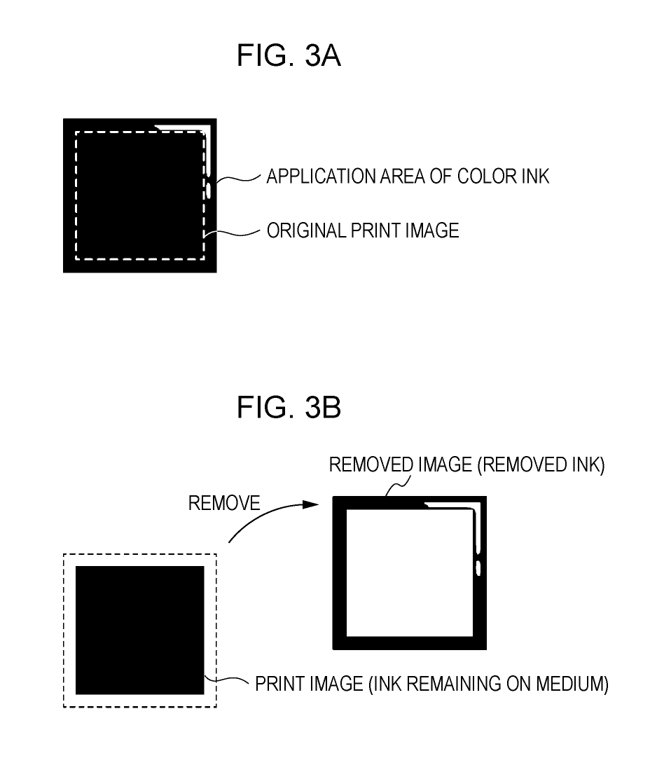

FIGS. 3A and 3B are diagrams illustrating an outline of embodiments according to the invention.

FIG. 3A is a diagram illustrating an application area of a color ink. The dotted line of FIG. 3A denotes an original print image. As shown in FIG. 3A, the application area of a color ink (a UV ink) is larger than that of the original print image.

Applying a color ink in such a way as shown in FIG. 3A causes the thick-protuberance phenomenon at the more inner side than the edge of the application area of the color ink. But, a protuberant portion along the edge thereof is formed at the outer side of the original print image. In other words, the application area of the color ink is determined so as to cause the protuberant portion due to the thick-protuberance phenomenon to be located at the outer side of the original print image.

FIG. 3B is a diagram illustrating a removal process according to this embodiment. The color ink having been applied at the outer side of an area enclosed by the dotted line of FIG. 3A is removed by performing the removal process. This process causes the color ink remaining on the medium to form the print image.

The protuberant portion due to the thick-protuberance phenomenon is removed by performing the removal process, and thus, any protuberant portions do not exist on the print image remaining on the medium. In this way, the feeling of a thick protuberance with respect to the print image is suppressed.

In the following description, an image, which is formed on the medium by the ink that is to be removed by performing the removal process, will be referred to as “a to-be-removed image”. The application area of the color ink shown in FIG. 3A corresponds to the area consisting of the original image and the to-be-removed image. Further, the to-be-removed image is formed at the outer side of the original print image.

Further, in a first embodiment described below, in order to make it easy to remove the color ink existing at the outer side of the original print image, a preliminary process is performed before applying the color ink. Specifically, as the preliminary process, a processing solvent repelling ink is applied onto formation areas of the to-be-removed images. In an improved example of the first embodiment, as the preliminary process, in order to not only apply the processing solvent repelling ink, but also prevent removal of the original print images to be remaining on the medium, a fixing solution (a fixing agent) is applied onto the formation areas of the original print images.

### First Embodiment

A configuration of a printing apparatus according to a first embodiment will be hereinafter described. In addition, such “a printing apparatus” is an apparatus for forming print images have been subjected to the removal process on a medium. For example, an apparatus (a system) including a printer 1 described below, and a computer 110 having a printer driver installed therein corresponds to the printing apparatus. Further, a controller 10 of the printer 1, and a computer 110 constitute a control section for performing control of the printing apparatus.

### Printer 1

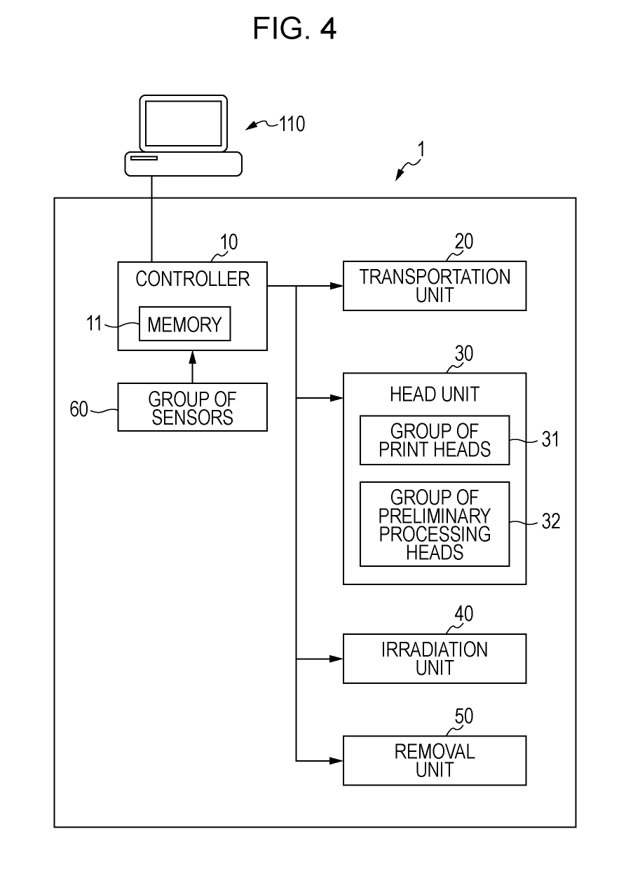

FIG. 4 is a block diagram illustrating an entire configuration of the printer 1.

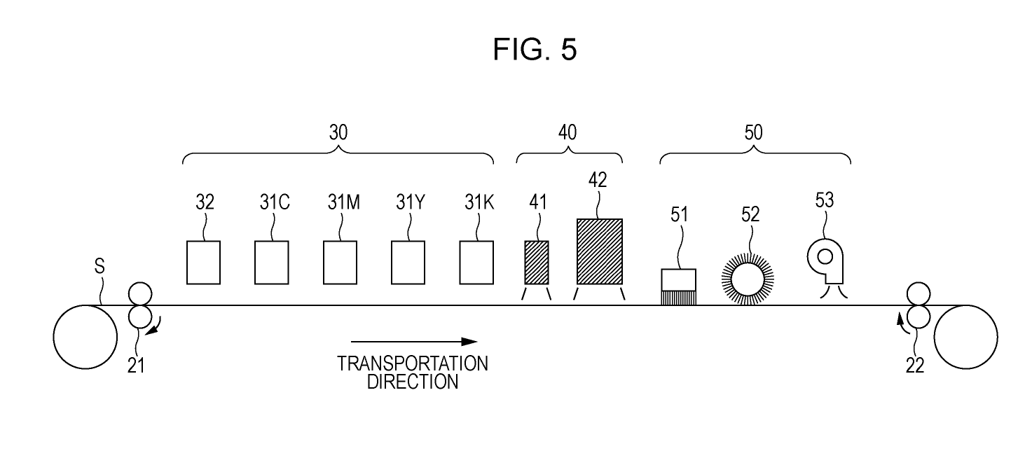

FIG. 5 is a diagram illustrating an entire configuration of the printer 1. The printer 1 according to this embodiment is a so-called line printer. In addition, the printer 1 may not be a line printer, but may be a serial printer (i.e., a printer including a head mounted on a carriage which is movable in the paper-width direction).

The printer 1 includes the controller 10, a transportation unit 20, a head unit 30, an irradiation unit 40, a removal unit 50 and a group of sensors 60. Upon reception of print data from the computer 110, which is a printing control apparatus, the printer 1 causes the controller 10 to perform control of the individual units (i.e., the transportation unit 20, the head unit 30, the irradiation unit 40, the removal unit 50 and the like).

The controller 10 is a control device for performing control of the printer 1. The controller 10 performs control of the individual units in accordance with programs stored in a memory 11. Further, the controller 10 prints images on a medium S by performing control of the individual units on the basis of print data having been received from the computer 110. Further, the controller 10 receives various detection signals having been detected by the group of sensors 60.

The transportation unit 20 is a unit for transporting the medium S (for example, paper, a film, or the like) in the transportation direction. This transportation unit 20 includes a transportation motor (not illustrated), an upstream-side roller 21 and a downstream-side roller 22. The rotation of the transportation motor (not illustrated) causes the upstream-side roller 21 and the downstream-side roller 22 to rotate; whereby the roll-type medium S is transported in the transportation direction.

The head unit 30 is a unit for ejecting liquids (inks, a processing solvent and the like) onto the medium S. The head unit 30 includes a group of print heads 31 and a group of preliminary processing heads 32. The group of print heads 31 includes heads for ejecting inks for formation of images. The group of print heads 31 includes a group of cyan heads 31C for ejecting a cyan ink, a group of magenta heads 31M for ejecting a magenta ink, a group of yellow heads 31Y for ejecting a yellow ink, and a group of black heads 31K for ejecting a black ink.

The group of preliminary processing heads 32 includes heads for ejecting a processing solvent used for a preliminary process. This preliminary process is a process for making it easy to remove to-be-removed images from the medium S along with causing print images to remain on the medium S when performing the removal process described below. The group of preliminary processing heads 32 is provided at the upper stream side than the group of print heads 31 in the transportation direction. The preliminary process performed by the group of preliminary processing heads 32 will be described below.

Each of the groups of heads (i.e., each of the group of print heads 31 and the group of preliminary processing heads 32) is provided with a plurality of heads which is arrayed in the paper-width direction (i.e., in a direction perpendicular to the paper surface in FIG. 5), and each of the heads is provided with a plurality of nozzles which is arrayed in the paper-width direction. In this way, each of the groups of heads can form dots equivalent to one paper width at one time. Ejecting the inks onto the medium S in a transported condition from the group of print heads 31 enables formation of two-dimensional print images on the print surface of the medium S. Further, ejecting the processing solvent onto the medium S in a transported condition from the group of preliminary heads 32 enables execution of the preliminary process on the printing surface of the medium S.

In this embodiment, UV inks are ejected through the individual nozzles of the group of print heads 31. The UV ink is an ink having the property of becoming cured upon receipt of irradiation of ultraviolet light rays. In addition, the UV ink has also the property of a high degree of viscosity, as compared with penetrative inks used for printing which is performed by causing inks to penetrate into a medium. Therefore, even taking into account a case where printing is performed onto regular paper, the UV ink is hard to be absorbed by media, as compared with the penetrative inks. The UV ink fixes dots to a medium by curing the dots, and thus, makes it possible to perform printing on even an ink-non-absorbent medium not including any ink-receptive layers. In addition, regarding the UV ink, a kind of ink described in JP-A-2006-199924 can be employed, but, other kinds of UV ink may be used.

Further, in this embodiment, a processing solvent, which has the property of repelling the UV ink, is ejected through each of the nozzles of the group of preliminary processing heads 32. Well-known examples of the processing solvent having the property of repelling the UV ink include fluorinated surface processing solvents. In this embodiment, regarding the surface processing solvent, the fluorinated surface processing solvent EGC-1720, which is a product of Sumitomo 3M limited, is employed. If necessary, processing may be performed so as to cause the group of print heads 31 to eject inks onto the medium S after causing a heater, which is provided between the group of preliminary processing heads 32 and the group of print heads 31, to heat and dry the processing solvent having been applied onto the medium S.

The irradiation unit 40 is a unit for irradiating the UV inks having been ejected onto the medium S with ultraviolet light rays. The irradiation unit 40 includes a tentative curing irradiation unit 41 and a full curing irradiation unit 42.

The tentative curing irradiation unit 41 is provided at the lower stream side in the print-area transportation direction (i.e., at the lower stream side of the head unit 30 in the transportation direction). The tentative curing irradiation unit 41 irradiates ultraviolet light rays having a certain degree of intensity enough to cure (tentatively cure) the surface of the UV inks so as not to cause drops of the UV inks having been applied to the medium S to be blurred by one another. For example, light-emitting diodes (LEDs) are employed as the tentative curing irradiation unit 41.

In addition, in this embodiment, one tentative curing irradiation unit is provided at the lower stream side of the head unit 30 in the transportation direction, but tentative curing irradiation units may be provided at the lower stream sides of the four-color groups of print heads (31C, 31M, 31Y and 31K) in the transportation direction, respectively.

The full curing irradiation unit 42 is provided at the lower stream side of the tentative curing irradiation unit 41 in the transportation direction. The full curing irradiation unit 42 irradiates ultraviolet light rays having a certain degree of intensity enough to make it possible to fully cured (completely cure) the UV inks existing on the medium. For example, UV lamps are employed as the full curing irradiation unit 42.

The removal unit 50 is a unit for removing the to-be-removed images (refer to FIG. 3B), which are formed at the outer side of corresponding print images, from the medium S. The removal unit 50 is provided at the lower side than the irradiation unit 40 in the transportation direction. The removal unit 50 includes an oscillating brush 51, a rotating brush 52 and an air blower 53.

The oscillating brush 51 and the rotating brush 52 are brushes for chipping off (tearing off) the to-be-removed images from the medium S by causing corresponding brushes thereof which are contacted with the print surface of the medium S to operate. The oscillating brush 51 performs brushing along the paper-width direction by oscillating a brush thereof in the paper-width direction of the medium S (i.e., in a direction perpendicular to the paper surface in FIG. 5). The rotating brush 52 performs brushing along the transportation direction by rotating a brush thereof around a shaft which is mounted along the paper-width direction. The direction of brushing performed by the oscillating brush 51 and the direction of brushing performed by the rotating brush 52 intersect with each other, and thus, it is possible to suppress the to-be-removed images from remaining on the medium S.

The air blower 53 is a blower for blowing away chips of inks, which have been chipped off from the medium S, from the print surface. The air blower 53 is provided at the upper stream side than the downstream-side roller 22 in the transportation direction; thereby enabling suppression of an operation in which the chipped-off ink chips are pressure bonded to the print surface by the downstream-side roller 22.

When performing printing, the controller 10 causes the transportation unit 20 to transport the medium S along the transportation direction. Further, along with causing the transportation unit 20 to transport the medium S, the controller 10 causes the group of preliminary heads 32 to eject the processing solvent to perform the preliminary process on the print surface of the medium S, and causes the heater to heat and dry the processing solvent having been applied onto the medium S if necessary. Moreover, along with causing the transportation unit 20 to transport the medium S, the controller 10 causes the group of print heads 31 to eject the UV inks onto the medium S to cause the UV inks to be applied onto areas covering the original print images and the to-be-removed images; causes the tentative curing irradiation unit 41 to irradiate ultraviolet light rays to cause dots having been formed by applying the UV inks onto areas to be tentatively cured; and causes the full curing irradiation unit 42 to irradiate ultraviolet light rays to cause the dots to be completely cured. Subsequently, the controller 10 causes the oscillating brush 51 and the rotating brush 52 to perform brushing to chip off the to-be-removed images from the medium S, and causes the air blower to blow away chipped-off ink chips. Further, the controller 10 causes the medium S having only the original print images remaining thereon to be reeled off at the position which is located at the lower stream side of the downstream-side roller 22 in the transportation direction.

### Computer 110 and Printer Driver

The computer 110 is connected to the printer 1 such that the computer 110 can communicate with the printer 1. Further, in order to cause the printer 1 to perform printing of images, the computer 110 outputs print data to the printer 1, which corresponds to the images to be printed.

The computer 110 includes a printer driver installed therein. The printer driver is a program for converting image data having been output from application programs into print data. This printer driver is recorded in a recording medium (a recording medium readable from computers), such as a CD-ROM. The printer driver can be also downloaded to the computer 110 via the Internet.

When a user of the printer 1 issues a command for printing an image the user has drawn on a certain application program, the printer driver of the computer 110 is activated. The printer driver receives image data from the application program, converts the image data into print data having a format which can be interpreted by the printer 1, and outputs the print data to the printer 1. When converting the image data from the application program into the print data, the printer driver performs a resolution conversion process, a color conversion process, a halftone process and the like. Moreover, the printer driver according to this embodiment also generates print data for ejecting the processing solvent for the preliminary process, and print data for forming the to-be-removed images.

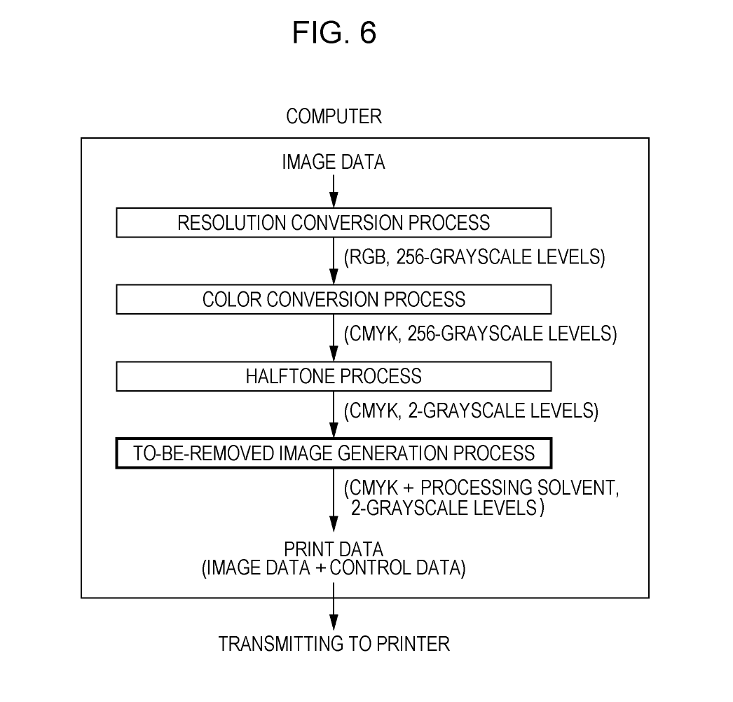

FIG. 6 is a diagram illustrating functions of a printer driver of the computer 110.

The resolution conversion process is a process for converting image data (text data, image data and the like), which has been output from an application program, into image data having a resolution (a print resolution) at which a corresponding image is printed on a medium. For example, in the case where the print resolution is specified to 720×720 dpi, vector-format image data having been received from an application program is converted into bit-map format image data having a resolution of 720×720 dpi. Each pixel data included in the image data having been subjected to the resolution conversion process is multi-gray-scale (for example, 256-gray-scale) RGB data which is represented by an RGB color space.

The color conversion process is a process for converting the RGB data into CMYK data which is represented by a CMYK color space. In addition, this CMYK data is data corresponding to colors of inks included in the printer. This color conversion processing is performed on the basis of a table (a color conversion lookup table LUT), in which the gray-scale values of the RGB data are caused to correspond to those of the CMYK data. In addition, each pixel data having been subjected to the color conversion process is 256-gray-scale CMYK data which is represented by a CMYK color space.

The half tone process is a process for converting data represented by multiple gray-scale levels into data represented by gray-scale levels at which a printer can form a print image corresponding to the data. For example, data representing 256 gray-scale levels is converted into one-bit data representing 2 gray-scale levels. In image data having been subjected to the halftone process, one-bit pixel data corresponds to each pixel. The one-bit pixel data is data representing the presence or absence of a corresponding dot. In addition, the pixel data may be two-bit data representing the size of a corresponding dot in addition to the presence or absence of the dot. In any of the foregoing cases, the pixel data having been subjected to the halftone process includes pieces of data each representing a corresponding dot to be formed on the medium.

A to-be-removed image generation process is a process for generating print data for forming to-be-removed images at the outer side of corresponding print images, such as shown in FIG. 3B.

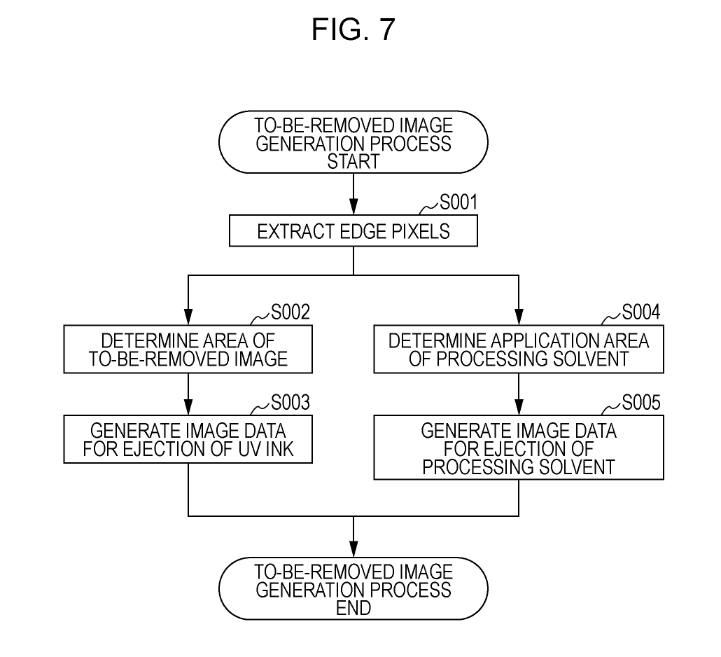

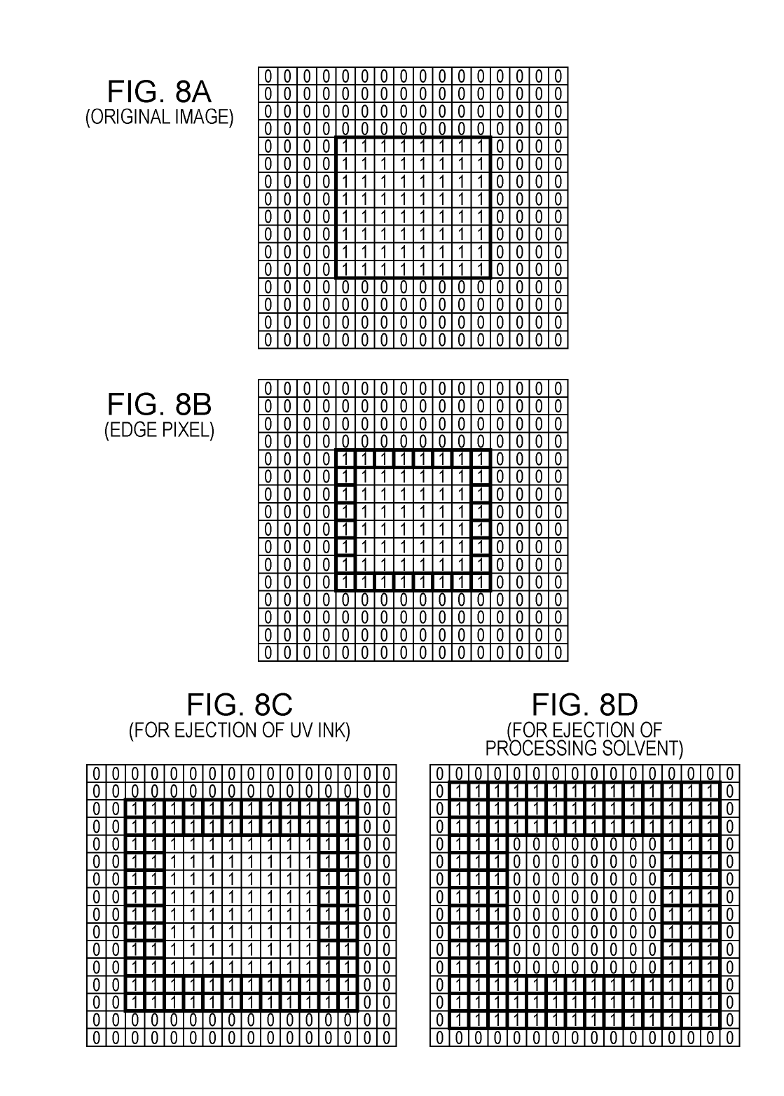

FIG. 7 is a flowchart illustrating the to-be-removed image generation process. FIGS. 8A to 8D are diagrams illustrating image data. FIG. 8A is a diagram illustrating image data (an original image) having been subjected to the halftone process. Here, it is assumed that one-bit pixel data is caused to correspond to each pixel. Further, it is assumed that a filled image of 8×8 pixels (refer to the thick-line portion of FIG. 8A) is included in the image data. Here, for the sake of simplification of description, only black image data will be described.

The printer driver performs an edge extraction process on the image data (refer to FIG. 8A) having been subjected to the halftone process, and thereby, extracts edge pixels which are located at the contour portion of the image (FIG. 7: S001). Here, pixels, each corresponding to the portion denoted by the thick frame in FIG. 8B, are extracted as the edge pixels.

Next, the printer driver determines areas of to-be-removed images on the basis of the edge pixels (FIG. 7: S002). Here, an area being located at the outer side of the edge pixels, and having a width equivalent to the size of a long side of an area consisting of adjacently arrayed two pixels, is determined as the area of the to-be-removed image. In addition, it is necessary to determine the areas of the to-be-removed images such that the areas thereof cover all protuberant portions due to the thick-protuberance phenomenon, and thus, in this case, actually, an area having a width larger than the size of a long side of an area consisting of adjacently arrayed two pixels is determined as the area of the to-be-removed image.

Next, in the image data shown in FIG. 8A, corresponding to an original image, the printer driver converts the values “0” of pieces of pixel data corresponding to respective pixels included in the area of the to-be-removed image into values “1,” and thereby, generates image data for ejection of the UV ink (FIG. 7: S003). FIG. 8C is a diagram illustrating the image data for ejection of the UV ink. As shown in FIG. 8C, for each of the pixels included in the area of the to-be-removed image, an original state, in which the relevant pixel is caused to correspond to pixel data having the value “0,” which indicates that a corresponding dot is not to be formed, is converted to a state, in which the relevant pixel is caused to correspond to pixel data having the value “1”, which indicates that a corresponding dot is to be formed.

In addition, in the image data for ejection of the UV ink, the original print image (the original image) is located inside the to-be-removed image. Any spaces do not exist between the original image and the to-be-removed image, and pixels, which are caused to correspond to respective pieces of pixel data each having the value “1” so as to form corresponding dots, are contiguously disposed.

Further, the printer driver determines application areas of the processing solvent on the basis of the edge pixels (refer to FIG. 8B) (FIG. 7: S004). Here, an area being located at the outer side of the edge pixels, and having a width equivalent to the size of a long side of an area consisting of adjacently arrayed three pixels, is determined as the area of the to-be-removed image (i.e., the application area of the processing solvent). The foregoing area of the to-be-removed image has a width corresponding to two pixels; while the width of the application area of the processing solvent is set to a width corresponding to three pixels. That is, the application area of the processing solvent is determined so as to be larger than the area of the to-be-removed image in the outward direction therefrom. This is because processing is performed such that any misalignment between the application area of the processing solvent and the application area of the UV ink does not cause the to-be-removed image to remain on the medium. In other words, this is because, if the width of the area of the to-be-removed image and the width of the application area of the processing solvent are set to the same size, any misalignment between the application area of the solvent and the application area of the UV ink makes it difficult to completely remove the to-be-removed image during the removal process, so that part of the to-be-removed image remains on the medium.

Next, the printer driver sets values of pieces of pixel data which are caused to correspond to respective pixels included within the application areas of the processing solvent to “1”, and sets values of the other pieces of pixel data to “0”, and thereby, generates image data for ejection of the processing solvent (FIG. 7: S005). FIG. 8D shows image data for ejection of the processing solvent. In addition, in this image data for ejection of the processing solvent, pixels included in an area which is located at the inner side the application area of the processing solvent are each in the state where the relevant pixel is caused to correspond to a piece of pixel data having the value “0”, which indicates that a corresponding dot is not to be formed. This is because the original print image is located at this area.

The computer 110 generates print data by adding control data to the image data including two gray-scale pixel data, which has been subjected to the to-be-removed image generation process, and transmits the print data to the printer 1 (refer to FIG. 6). Upon reception of the print data, the printer 1 performs control of the individual units in accordance with the control data included in the print data so as to cause the group of preliminary processing heads 32 to eject the processing solvent in accordance with the image data for ejection of the processing solvent (refer to FIG. 8D), and cause the group of print heads 31 to eject the UV ink through the individual nozzles thereof in accordance with the image data for ejection of the UV ink (refer to FIG. 8C), and thereby, prints a target image on a medium.

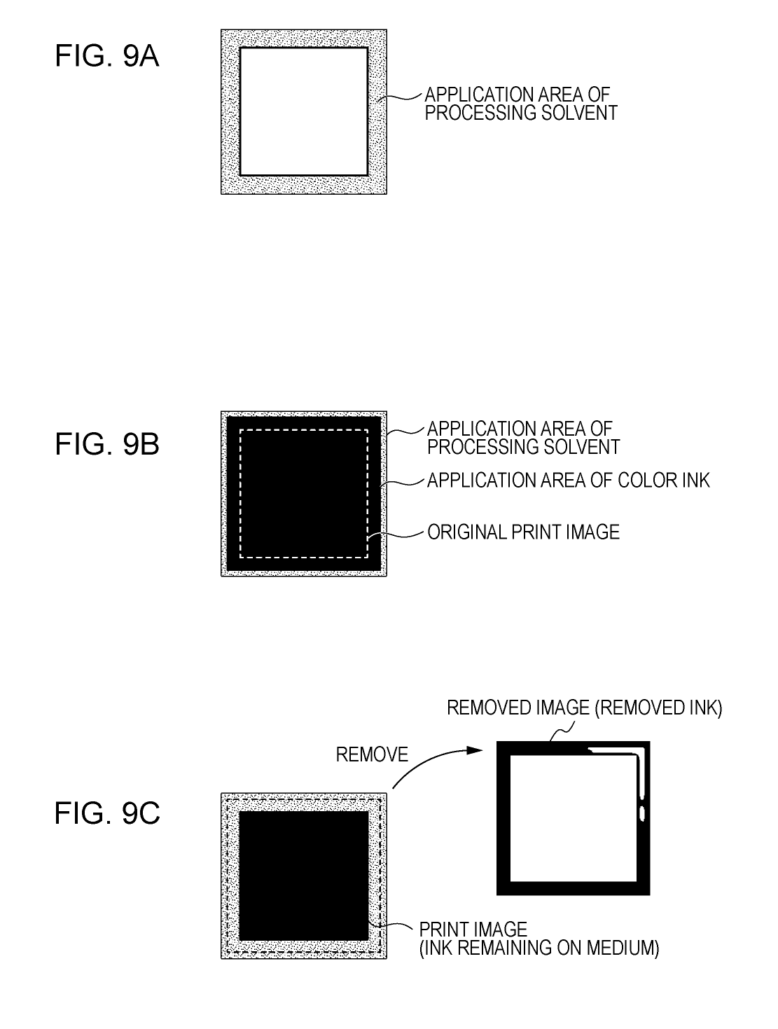

FIGS. 9A to 9C are diagrams illustrating states of the print surface of a medium when printing processing is performed.

While transporting the medium S, the printer 1 applies the processing solvent onto an application area of the processing solvent, shown in FIG. 9A, by ejecting the processing solvent through the individual nozzles of the group of preliminary processing heads 32 in accordance with the image data for application of the processing solvent (refer to FIG. 8D). In addition, in FIG. 9A, the application area of the processing solvent is denoted by a sand-like pattern, but, actually, the processing solvent is colorless, and thus, is hard to be viewed.

After the application of the processing solvent, while transporting the medium S, the printer 1 applies the UV ink onto an application area of the UV ink, which corresponds to the area filled with black color in FIG. 9B, by ejecting the UV ink through the individual nozzles of the group of print heads 31 in accordance with the image data for ejection of the UV ink (refer to FIG. 8C). Through this process, the UV ink has been applied onto the area covering the original print image, and the to-be-removed image located at the outer side of the original image. Within the area of the to-be-removed image, the UV ink has been applied onto the portion on which the processing solvent is already applied. The processing solvent has the property of repelling the UV ink, and thus, the UV ink having been applied onto the processing solvent is unlikely to become fixed to the medium S.

In addition, the processing solvent is applied on the area larger than the to-be-removed image in the outward direction, and thus, any misalignment of the application area of the UV ink does not cause the UV ink to be applied onto a portion which is located at the outer side of the application area of the processing solvent (refer to FIG. 9A).

After having applied the UV ink, such as shown in FIG. 9B, the printer 1 causes dots having been formed by ejecting the UV ink to be tentatively cured by causing the tentative curing irradiation unit 41 to irradiate the dots with ultraviolet light rays, and further, causes the dots to be completely cured by causing the full curing irradiation unit 42 to irradiate the dots with ultraviolet light rays. Usually, when the UV ink is cured, along therewith, the dots (the UV ink) become (becomes) fixed to the medium. But, within the area of the to-be-removed image, the preliminary process has been performed so as to repel the UV ink, and thus, the UV ink is not fixed to the medium.

Subsequently, the printer 1 performs a brushing process on the cured print image by using the oscillating brush 51 and the rotating brush 52. In this case, within the area having been subjected to the preliminary process, the UV ink is not fixed to the medium, and thus, the UV ink is chipped off by performing the brushing process (this process corresponds to the foregoing removal process). In contrast, within the area having not been subjected to the preliminary process, dots are firmly fixed to the medium, and thus, the UV ink remains fixed to the medium although having been subjected to the brushing process. As a result of this brushing process, as shown in FIG. 9C, the original print image remains on the medium as it is; while the to-be-removed image, which is located at the outer side of the original image, is chipped off from the medium.

In addition, in this embodiment, the UV ink which is already cured is chipped off by performing the brushing process. Therefore, as compared with a method of removing the UV ink which has not yet been cured, the to-be-removed image can be removed (can be exfoliated) from the medium more completely.

Finally, the printer 1 blows away chipped-off chips of ink by using the air blower 53. As a result of this process, the printer 1 can achieve printing of an image just like the original image (refer to FIG. 8A).

As described above, according to this embodiment, when printing of images is performed onto a medium by applying UV inks (photo-curable inks) onto the medium, first, the printer 1 ejects the UV inks onto the medium through the individual nozzles of the group of print heads 31 such that the UV inks are applied onto an increased portion of an area resulting from expansion of each of original areas, onto which the UV inks are originally to be applied in order to achieve printing of the images, in an outward direction of the each of the original area from an entire edge thereof, in addition to the each of the original areas, and subsequently, cures the UV inks by irradiating the UV inks with light rays from the irradiation unit 40 (an irradiation portion). Further, the printer 1 removes to-be-removed images, each of which is formed within the increased portion, from the medium by using the removal unit 50. Through these processes, protuberant portions due to the thick-protuberance phenomenon have been removed, so that any protuberant portions due to the thick-protuberance phenomenon do not exist on the print images remaining on the medium, and thus, the feeling of a thick protuberance with respect to the print images can be suppressed.

Further, according to this embodiment, before applying the UV inks onto the medium, a processing solvent, which has the property of repelling the UV inks, is applied onto the areas of the to-be-removed images (i.e., the increased portions of corresponding areas resulting from expansion of the original areas, onto which the UV inks are originally to be applied). In this way, it is possible to easily remove the to-be-removed images from the medium.

Furthermore, according to this embodiment, the processing solvent is applied onto areas each resulting from expansion of the corresponding increased portion in an outward direction of the increased portion from an entire edge of the increased portion, excluding an edge contacted with the corresponding original area (refer to FIGS. 8C, 8D and 9B). In this way, any misalignment of each of the application areas of the UV inks does not cause the UV inks to be applied onto a portion which is located at the outer side of the corresponding application area of the processing solvent (refer to FIG. 9A), and thus, it is possible to suppress the to-be-removed UV inks from remaining on the medium.

Further, according to this embodiment, the printer 1 includes the oscillating brush 51 and the rotating brush for chipping off the UV inks. Further, a direction in which the oscillating brush 51 chips off the UV inks (i.e., the paper-width direction) and a direction in which the rotating brush 52 chips off the UV inks (i.e., the transportation direction) are different from each other. In this way, it is possible to suppress the to-be-removed images from remaining on the medium S.

Furthermore, according to this embodiment, the printer 1 includes an air blower for blowing away chips of ink (i.e., chips of the photo-curable ink), which have been chipped off from the medium. In this way, it is possible to suppress re-adherence of the chipped-off chips of ink to the print surface of the medium.

### Improved Example of First Embodiment

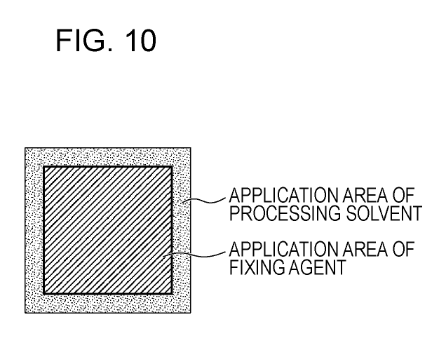

FIG. 10 is a diagram illustrating a state of a print surface of a medium having been subjected to a preliminary process, according to an improved example of the first embodiment.

In this improved example, the preliminary processing head 32 includes not only nozzles through which the processing solvent repelling the UV inks is ejected, but also nozzles through which the fixing agent (the fixing solution) is ejected. Further, in this improved example, the preliminary head 32 applies not only the processing solvent repelling the UV inks, but also the fixing agent (the fixing solution) onto the medium.

The fixing agent is applied onto the areas of the original print images (i.e., the areas onto which the UV inks are to be originally applied in order to achieve printing of target images). In this way, it is possible to prevent print images to be remaining on the medium from removing from the medium during the removal process.

### Modified Example of First Embodiment

In the foregoing first embodiment, the UV inks are chipped off by using two members of the oscillating brush 51 and the rotating brush 52, but the UV inks may be chipped off by using any one of the two kinds of brushes. In addition, there is a risk that this method increases the possibility of occurrence of remaining of the to-be-removed UV inks on the medium.

Further, in the foregoing first embodiment, two kinds of brushes (the oscillating brush 51 and the rotating brush 52) are employed as members for chipping off the UV inks. But, the members for chipping off the UV ink are not limited to such brushes. For example, the UV inks may be chipped off by using members each having a sharp blade, such as a knife, or members each having a sharp tip, such as a needle.

Further, when the to-be-removed images are removed, the UV inks may not be chipped off, but may be exfoliated by using, for example, an adhesive tape.

### Second Embodiment

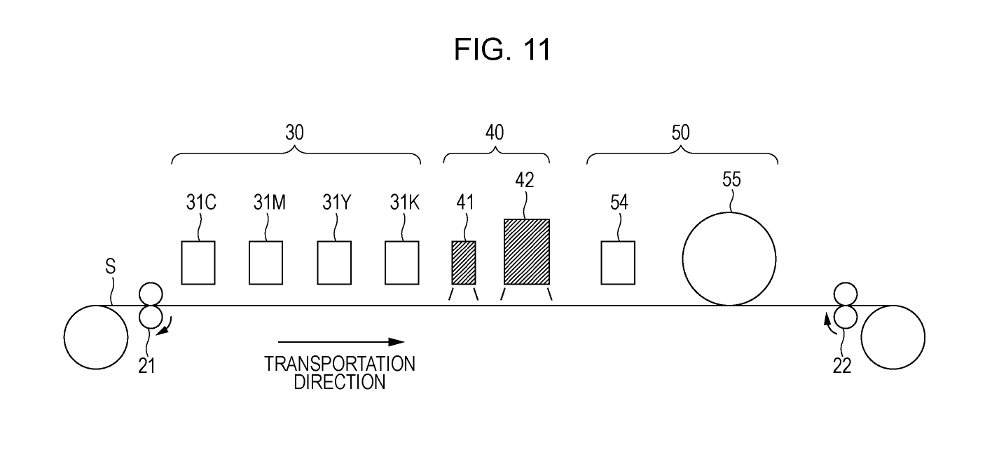

FIG. 11 is a diagram illustrating a printing apparatus according to a second embodiment of the invention. For processes performed in the second embodiment, the preliminary process is not performed, as compared with those performed in the first embodiment. Further, the configuration and means of the removal unit 50 according to the second embodiment are different from those according to the first embodiment. According to the first embodiment, the to-be-removed images are chipped off by a physical means; while according to the second embodiment, the to-be-removed images are chipped off by a chemical means.

The removal unit 50 according to the second embodiment includes a solvent ejection head 54 and a collection roller 55.

The solvent ejection head 54 includes nozzles through which a solvent for dissolving the UV inks is ejected. Further, the controller 10 causes the solvent ejection head 54 to eject the solvent such that the solvent is applied onto areas of the to-be-removed images. In this embodiment, for example, glycol ether is used as the solvent.

The collection roller 55 is a roller for collecting the UV inks having been dissolved by the solvent by causing the dissolved UV inks to adhere to the surface of the roller. The collection roller 55 is provided at the upper stream side than the downstream-side roller 22 in the transportation direction; thereby enabling suppression of adhesion of the UV inks existing on the areas of the to-be-removed images, which have been dissolved by the solvent, to the downstream-side roller 22.

In this second embodiment, similarly, when printing of images is performed onto a medium by applying UV inks (photo-curable inks) onto the medium, first, the printer 1 ejects the UV inks onto the medium through the individual nozzles of the group of print heads 31 such that the UV inks are applied onto an increased portion of an area resulting from expansion of each of original areas, onto which the UV inks are originally to be applied in order to achieve printing of the images, in an outward direction of the each of the original areas from an entire edge of the each of the original areas, in addition to the each of the original areas, and subsequently, cures the UV inks by irradiating the UV inks with light rays from the irradiation unit 40 (an irradiation portion). Further, the printer 1 removes to-be-removed images, which are formed within the corresponding increased portions, from the medium by using the removal unit 50. Through these processes, protuberant portions due to the thick-protuberance phenomenon have been removed, so that any protuberant portions due to the thick-protuberance phenomenon do not exist on the print images remaining on the medium, and thus, the feeling of a thick protuberance with respect to the print images can be suppressed.

### Other Embodiments

The foregoing embodiments are ones which make it easy to understand the invention, but are not ones which limit the interpretation of the invention. Naturally, the invention can be modified or improved without departing the gist of the invention, and further, the invention includes equivalents of the invention.

### Regarding Filled Image

The filled image corresponding to image data having been subjected to the foregoing halftone process is such an image that causes each of pixels included therein to form a corresponding dot. But, processing is not limited to such a process. The filled image may be such an image that is generated merely in order to fill a certain area of a medium with ink, and may include some pixels, for each of which any corresponding dot is not formed.

### Regarding Line Printer

The foregoing printer 1 is a so-called line printer, in which rows of dots arrayed along a transportation direction are formed in conjunction with transportation of a medium relative to fixed heads. But, the printer 1 is not limited to such a line printer. For example, the printer 1 may be a printer (a so-called serial printer) which has a head mounted on a carriage movable in a main direction, and alternatively repeats a dot formation operation for forming rows of dots arrayed along the main scanning direction by causing the head in a moving condition to eject the UV inks, and a transportation operation for transporting a medium.

For such a serial printer, it is possible to form rows of dots at intervals of a distance smaller than a nozzle pitch. That is, it is possible to achieve a higher print resolution than the nozzle pitch. Therefore, the foregoing resolution of image data may not be the same as a nozzle pitch, but may be higher than the nozzle pitch.

### Regarding Processing Performed by Computer 110

The foregoing computer 110 performs the resolution conversion process, the color conversion process, the halftone process, the to-be-removed image generation process and the like. But, part of or entire of these processes may be performed at the printer 1 side. In the case where the to-be-removed image generation process performed by the computer 110 is performed at the printer 1 side instead thereof, the printer 1 corresponds to “the printing apparatus” independently because, in this case, the printer 1 can generate the to-be-removed images independently.

### Regarding Removal Unit 50

The foregoing printer 1 includes the removal unit 50. But, the printer 1 may not include any removal units. Further, after the printer 1 has performed printing of images by applying the UV inks onto an increased portion of an area resulting from expansion of each of original areas onto which the UV inks are originally to be applied, a user may remove the to-be-removed images by using a knife and the like. In this way, similarly, protuberant portions due to the thick-protuberance phenomenon are removed, so that any protuberant portions due to the thick-protuberance phenomenon do not exist on the print images remaining on the medium, and thus, the feeling of a thick protuberance regarding the print images can be suppressed.

The entire disclosure of Japanese Patent Application No. 2011-097394, filed Apr. 25, 2011 is expressly incorporated by reference herein.

What is claimed is:

1. A printing apparatus comprising:
an ink ejection nozzle configured to eject a photo-curable ink, which is cured upon receipt of irradiation of light, onto a medium; and
an irradiation portion configured to irradiate the photo-curable ink having been applied to the medium with the light,
wherein, when printing of an image is performed onto the medium by applying the photo-curable ink, the printing apparatus
ejects the photo-curable ink onto the medium through the ink ejection nozzle such that the photo-curable ink is applied onto an increased portion of an area resulting from expansion of at least one original area, onto which the photo-curable ink is originally to be applied in order to achieve printing of the image, in an outward direction of the at least one original area from an entire edge of the at least one original area, in addition to the at least one original area;
cures the photo-curable ink having been applied to the medium by irradiating the photo-curable ink with the light from the light irradiation portion; and
removes the photo-curable ink having been applied onto the increased portion from the medium.

2. The printing apparatus according to claim 1, wherein, before applying the photo-curable ink, a processing solvent which has a property of repelling the photo-curable ink is applied onto the increased portion.

3. The printing apparatus according to claim 2, wherein the processing solvent is applied onto an area resulting from expansion of the increased portion in an outward direction of the increased portion from an entire edge of the increased portion, excluding an edge contacted with the at least one original area.

4. The printing apparatus according to claim 1, wherein, before applying the photo-curable ink, a fixing agent for fixing the photo-curable ink to the medium is applied onto the at least one original area.

5. The printing apparatus according to claim 1, further comprising:
a first member and a second member configured to chip off the photo-curable ink from the medium,
wherein a direction in which the first member chips off the photo-curable ink and a direction in which the second member chips off the photo-curable ink are different from each other.

6. The printing apparatus according to claim 1, further comprising an air blower configured to blow away chips of the photo-curable ink having been chipped off from the medium.

7. A printing method for performing printing of an image onto a medium by using a photo-curable ink which is cured upon receipt of irradiation of light, the printing method comprising:
ejecting the photo-curable ink onto the medium through an ink ejection nozzle such that the photo-curable ink is applied onto an increased portion of an area resulting from expansion of at least one original area, onto which the photo-curable ink is originally to be applied in order to achieve printing of the image, in an outward direction of the at least original area from an entire edge of the at least one original area, in addition to the at least one original area;
curing the photo-curable ink having been applied to the medium by irradiating the photo-curable ink with the light; and
removing the photo-curable ink having been applied onto the increased portion from the medium.
